(19) United States
(12) Patent Application Publication
(10) Pub. No.: US 2016/0337124 A1
(43) Pub. Date: Nov. 17, 2016

(54) SECURE BACKUP AND RECOVERY SYSTEM FOR PRIVATE SENSITIVE DATA

(71) Applicant: Michael Rozman, Rosh Ha'Ayin (IL)

(72) Inventor: Michael Rozman, Rosh Ha'Ayin (IL)

(21) Appl. No.: 14/782,795

(22) PCT Filed: Apr. 10, 2014
(86) PCT No.: PCT/IB2014/060622

§ 371 Date: Oct. 7, 2015

(30) Foreign Application Priority Data
Apr. 10, 2013 (US) 61810281

(51) Int. Cl. H04L 9/08; G06F 21/62

(52) U.S. Cl. CPC H04L 9/0894; G06F 21/6245; G06F 21/6209; H04L 9/085; G06F 2221/2107

(57) ABSTRACT

A device includes a backup activator and a backup generator. The backup activator decrypts an encrypted concealed snapshot of a user's secret using a protection key, producing a concealed snapshot, and reconstructs a snapshot from the concealed snapshot, the user's password and a multiparty secret reconstruction system. The backup generator conceals the snapshot with a password of the user and the multiparty secret protection system, generates the protection key and encrypts the concealed snapshot with the protection key. The backup activator includes a helper based key recovery unit which sends encrypted portions of the protection key, each portion being associated with and decryptable by a helper, and which combines decrypted portions into the protection key. The backup generator includes a helper based key encrypter to split the protection key into at least one portion per an associated helper and to encrypt each portion with the associated helper's public key.

### CROSS REFERENCE TO RELATED APPLICATIONS

This application claims priority from U.S. Provisional Patent Application 61/810,281, filed Apr. 10, 2013, which application is incorporated herein by reference.

### FIELD OF THE INVENTION

The present invention relates generally to the protection and backup of personal secrets.

### BACKGROUND OF THE INVENTION

A multiparty secret protection system, described in U.S. provisional patent application 61/867,183, filed Aug. 19, 2013 and in a copending PCT Patent Application PCT/IB2014/060619 filed on the same day herewith entitled “Multiparty Secret Protection System”, both assigned to the common assignee of the present invention and both incorporated herein by reference, allows users of personal computing devices to rely on their devices for strong remote authentication, for digital signatures and for secure storage of private sensitive data. Such usage of personal computing devices poses the challenge of how to allow users to resume working in case devices get lost, stolen, damaged or disposed.

The multiparty secret protection system stores concealed (encrypted) private sensitive data (including private cryptographic keys) on personal devices. Unless backup copies exist for the concealed data, it would not be possible for users who lost their devices (or if the devices were stolen, damaged or disposed) to migrate to new devices and resume working. Due to the manner of concealment of the multiparty secret protection system, concealed backup copies cannot be used (if they were somehow leaked) to reveal the private data unless the user's password is known to the attackers. Accordingly, it would seem that a user could load a backup to a new personal device and reconstruct the secret data with the password. However, keeping such backups regularly is too risky because:

Since the secret protection system will lock out a user if they attempt to reconstruct the secret too many times with an incorrect password, attackers could disable a leaked backup just by triggering secret reconstruction with an incorrect password. In such case the owner of the data will be locked out of his backup.

Some users might fail to keep their password secret at all times and under all circumstances.

### SUMMARY OF THE PRESENT INVENTION

There is provided, in accordance with a preferred embodiment of the present invention, a device includes a backup activator and a backup generator. The backup activator decrypts an encrypted concealed snapshot of a user's secret using a protection key, producing a concealed snapshot, and reconstructs a snapshot from the concealed snapshot, the user's password and a multiparty secret reconstruction system. The backup generator conceals the snapshot with a password of the user and the multiparty secret protection system, generates the protection key and encrypts the concealed snapshot with the protection key. The backup activator includes a helper based key recovery unit which sends encrypted portions of the protection key, each the portion being associated with and decryptable by a helper, and which combines decrypted portions into the protection key. The backup generator includes a helper based key encrypter to split the protection key into at least one portion per an associated helper and to encrypt each portion with the associated helper's public key.

There is also provided, in accordance with a preferred embodiment of the present invention, a device including a helper based key recovery unit and a helper based key encrypter. The helper based key recovery unit sends encrypted portions of a protection key to a message exchange service, each portion being associated with at least one helper, and combines decrypted portions into the protection key. The decrypted portions are received from the message exchange service after a user of the device requests that each helper retrieve his or her associated portion from the message exchange service and after the helper enables his or her associated portion to be decrypted using his or her private key and sent back to the message exchange service. The helper based key encrypter splits the protection key into at least one portion per associated helper and encrypts each portion with the associated helper's public key.

Moreover, in accordance with a preferred embodiment of the present invention, the helper based key encrypter includes a secret splitter and an encrypter. The secret splitter splits the protection key into at least one secret share per associated helper. The encrypter encrypts the at least one secret share per associated helper together with an identification of the user using the associated helper's public key into a ciphertext per associated helper.

Furthermore, in accordance with a preferred embodiment of the present invention, the helper based key encrypter also includes a combiner to combine each ciphertext per helper with at least an identification of its associated helper to generate the portion per associated helper.

Still further, in accordance with a preferred embodiment of the present invention, the helpers are organized into groups, and wherein each helper has one share per each group to which s/he belongs.

Moreover, in accordance with a preferred embodiment of the present invention, at least one of the associated helpers is an automated helper which communicates with the helper based key recovery unit directly.

Further, in accordance with a preferred embodiment of the present invention, the key recovery unit includes a code provider to generate a verification code and to instruct the user to provide the verification code to at least one the helper via an oral communication.

Further, in accordance with a preferred embodiment of the present invention, the key recovery unit includes a message generator to generate a recovery message per helper, wherein each message comprises at least one of an associated encrypted portion for the helper, the verification code associated with the helper and a response key for the helper.

Still further, in accordance with a preferred embodiment of the present invention, each helper has a helper assistance unit to receive the recovery message, to decrypt the associated encrypted portion with the helper's public key, the encrypted portion comprising an identification of the user, to present the identification of the user to the helper, to receive the verification code for the user from the helper, to compare the verification code from the helper to the verification code in the recovery message, and to transmit the decrypted associated portion back to the message exchange service.

Additionally, in accordance with a preferred embodiment of the present invention, the device includes a backup activator and a backup generator. The backup activator decrypts an encrypted concealed snapshot of a user's secret, producing a concealed snapshot, using the output of the recovery unit, and reconstructs a snapshot from the concealed snapshot, the user's password and a multiparty secret reconstruction system. The backup generator conceals the snapshot with a password of the user and the multiparty secret protection system, generates the protection key and encrypts the concealed snapshot with the protection key.

Further, in accordance with a preferred embodiment of the present invention, the multiparty secret protection system operates with snapshot counters to enable servers of the multiparty secret protection system to determine whether a reconstruction request comes from reconstruction of a valid snapshot, a reconstruction attempt of a revoked snapshot, normal operation of a valid device, or a revoked device.

There is also provided, in accordance with a preferred embodiment of the present invention, a method including sending encrypted portions of a protection key to a message exchange service, each portion being associated with at least one helper, combining decrypted portions into the protection key, the decrypted portions being received from the message exchange service after a user requests that each at least one helper retrieve his or her associated portion from the message exchange service and after the at least one helper enables his or her associated portion to be decrypted using his or her private key and sent back to the message exchange service, splitting the protection key into at least one portion per an associated helper, and encrypting each portion with the associated helper's public key.

Moreover, in accordance with a preferred embodiment of the present invention, the splitting includes secret splitting the protection key into at least one secret share per associated helper. The encrypting includes encrypting the at least one secret share per associated helper together with an identification of the user using the associated helper's public key into a ciphertext per associated helper.

Furthermore, in accordance with a preferred embodiment of the present invention, the encrypting also includes combining each ciphertext per helper with at least an identification of its associated helper to generate the portion per associated helper.

Still further, in accordance with a preferred embodiment of the present invention, at least one of the associated helpers is an automated helper. The sending sends the encrypted portions directly to the automated helper.

Moreover, in accordance with a preferred embodiment of the present invention, the combining includes generating a verification code and instructing the user to provide the verification code to at least one the helper via an oral communication.

Further, in accordance with a preferred embodiment of the present invention, the combining includes generating a recovery message per helper, wherein each message comprises at least one of an associated encrypted portion for the helper, the verification code associated with the helper and a response key for the helper.

Moreover, in accordance with a preferred embodiment of the present invention, the method includes each helper having a helper assistance unit to receive the recovery message, to decrypt the associated encrypted portion with the helper's public key, the encrypted portion comprising an identification of the user, to present the identification of the user to the helper, to receive the verification code for the user from the helper, to compare the verification code from the helper to the verification code in the recovery message, and to transmit the decrypted associated portion back to the message exchange service.

Additionally, in accordance with a preferred embodiment of the present invention, the method also includes decrypting an encrypted concealed snapshot of a user's secret to produce a concealed snapshot, using the output of the combining, reconstructing a snapshot from the concealed snapshot and the user's password, with a multiparty secret reconstruction system, concealing the snapshot with a password of the user and the multiparty secret protection system, generating the protection key and encrypting the concealed snapshot with the protection key.

Furthermore, in accordance with a preferred embodiment of the present invention, the multiparty secret protection system operates with snapshot counters to enable servers of the multiparty secret protection system to determine whether a reconstruction request comes from reconstruction of a valid snapshot, a reconstruction attempt of a revoked snapshot, normal operation of a valid method, or a revoked method.

Finally, in accordance with a preferred embodiment of the present invention, there is provided a method including decrypting an encrypted concealed snapshot of a user's secret using a protection key, producing a concealed snapshot and reconstructing a snapshot from the concealed snapshot, the user's password and a multiparty secret reconstruction system. The decrypting includes sending encrypted portions of the protection key, each portion being associated with and decryptable by a helper, and combining decrypted portions into the protection key. The method also includes concealing the snapshot with a password of the user and the multiparty secret protection system, generating the protection key and encrypting the concealed snapshot with the protection key. The generating includes splitting the protection key into at least one portion per an associated helper and encrypting each portion with the associated helper's public key.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a backup and recovery system for private sensitive data, constructed and operative in accordance with a preferred embodiment of the present invention;

FIG. 2 is a schematic illustration of a snapshot concealment process, useful in the system of FIG. 1;

FIG. 3 is a schematic illustration of a key recovery operation, useful in the system of FIG. 1;

FIG. 4 is a schematic illustration of an exemplary helper based key encryption process, useful in the system of FIG. 1;

FIG. 5 is a schematic illustration of the elements of a recovery message and a decrypted portion message, useful in the system of FIG. 1; and

FIG. 6 is a tabular illustration of the states of a snapshot counter, useful in the system of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The multiparty secret protection system described in U.S. provisional patent application 61/867,183 and in the copending PCT Patent Application PCT/IB2014/060619 filed on the same day herewith entitled “Multiparty Secret Protection System” stores concealed private sensitive data on personal devices. Applicants have realized that further encrypting concealed snapshots of the sensitive data in such a way that cooperation of one or more testable persons or machines (identification helpers) is required for decryption, may provide backup files that enable users who lost their devices to migrate to new devices and to resume working in a few simple steps, with minimal risk. The method may also include automatic revocation of all previous backups of a user upon creation of a new backup and may include automatic revocation of the old device once migration to a new device is complete.

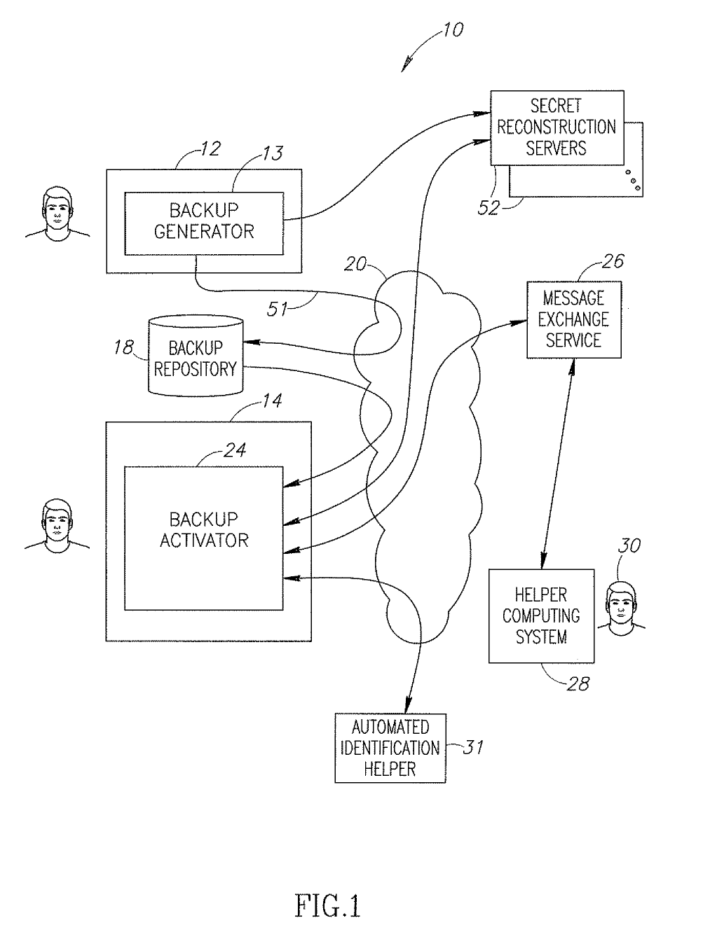

Reference is now made to FIG. 1, which illustrates the backup and recovery system 10 of the present invention with an old device 12 and a new device 14. System 10 comprises a backup generator 13 on old device 12, a backup repository 18, typically connected across a network 20, and a backup activator 24 on new device 14. As described in more detail hereinbelow, system 10 may operate with secret reconstruction servers 52 generally in accordance with the multiparty secret protection system, described in U.S. provisional patent application 61/867,183 and in the copending PCT Application PCT/IB2014/060619, mentioned above and adjusted to work with snapshots, as described hereinbelow.

System 10 also operates with one or more identification helpers, generally via a message exchange service 26. Identification helpers may be human helpers 30 or automated helpers 31, where a human identification helper 30 may be a friend, acquaintance or relative of a user that the user generally (if not fully) trusts. Human helpers 30 may also be anyone of a group of people that can identify the user, such as a customer service team at a bank. Note that any individual in such group may be able to identify the user.

The automated helper 31 may be a computing system that is able to identify and authenticate the user through remote interaction. For example, several banks' computer systems can identify customers of the bank by presenting questions regarding the activity at their bank account and examining the answers.

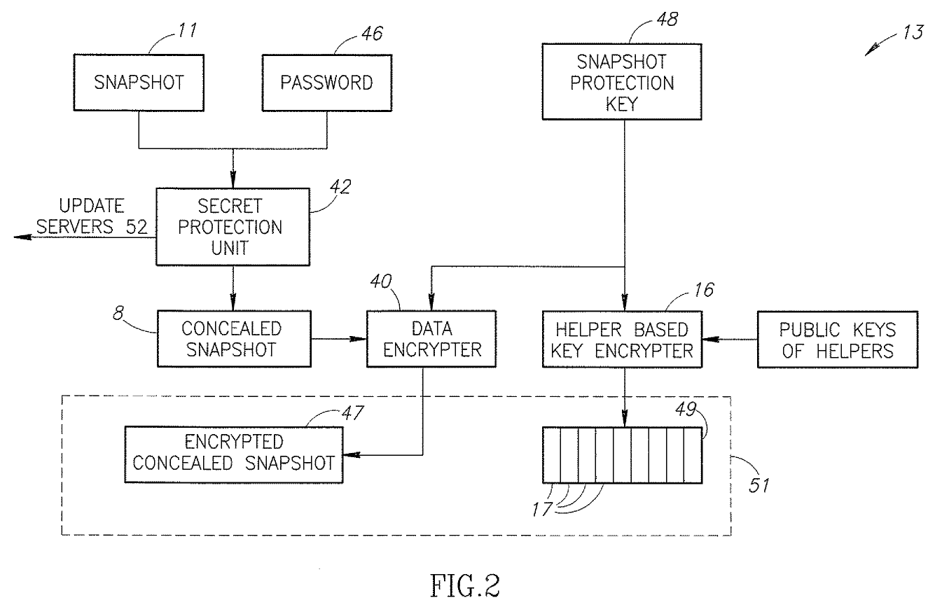

As shown in FIG. 2 to which reference is now briefly made, backup generator 13 may also comprise a data encrypter 40 and a secret protection unit 42. Secret protection unit 42 may encrypt a snapshot 11, given a user's password 46, using the secret concealment process, described in U.S. Ser. No. 61/867,183 and in the copending PCT Application PCT/IB2014/060619, and adjusted to work with snapshots. During the process, protection unit 42 may create a concealed snapshot 8 from snapshot 11 and password 46. As described hereinbelow, secret protection unit 42 may update servers 52 that a new snapshot has been produced.

Data encrypter 40 may utilize a snapshot protection key 48 to encrypt concealed snapshot 8, producing an encrypted concealed snapshot 47. In accordance with a preferred embodiment of the present invention, helper based key encrypter 16 may split snapshot protection key 48 into a plurality of helper portions, each generally encrypted, together with identifying details of the user, with the public key of its associated helper, to generate M recovery portions 17 forming a key recovery file 49.

Backup generator 13 may then store encrypted concealed snapshot 47 and key recovery file 49 as a backup file 51 (FIG. 1) in backup repository 18. When the user wants to migrate to new device 14, backup activator 24 (FIG. 1) may download the most recent backup file 51 from backup repository 18.

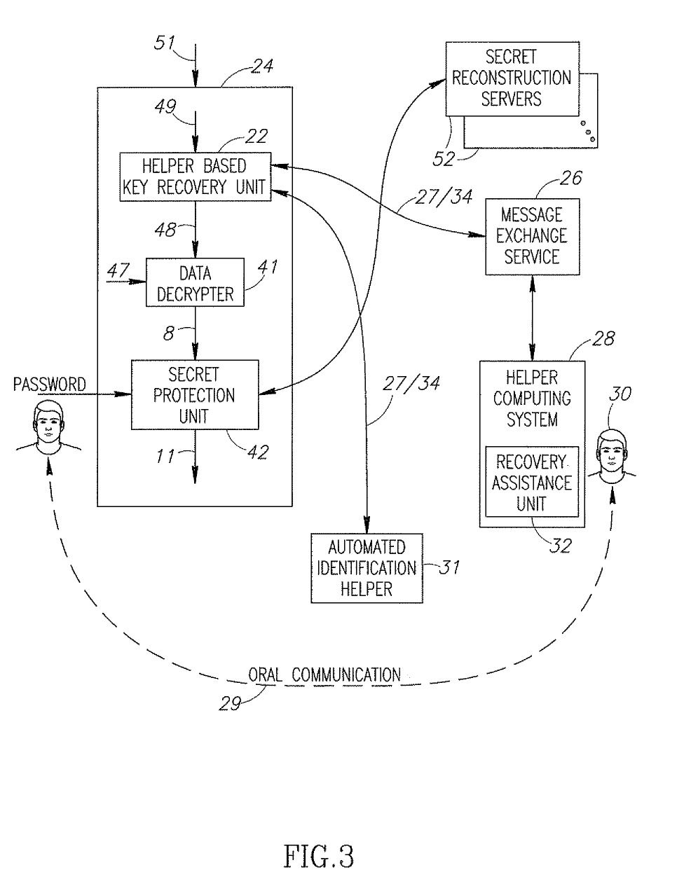

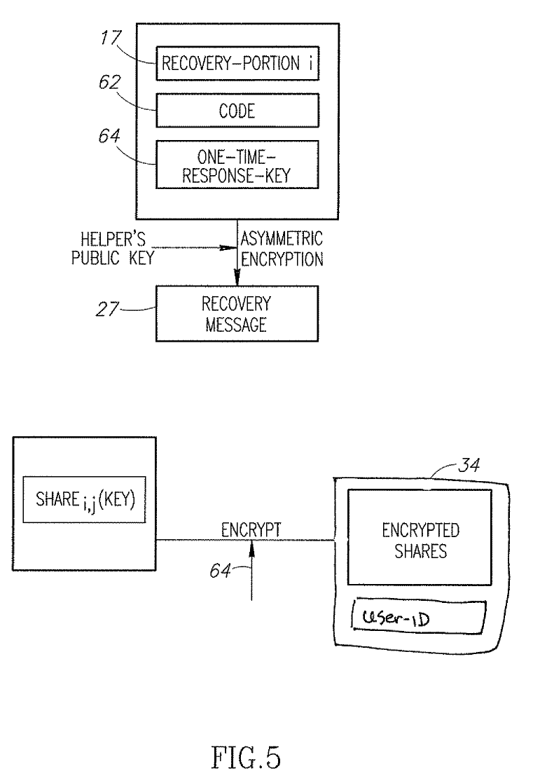

Reference is now made to FIG. 3, which illustrates the elements of backup activator 24 and its operation. Backup activator 24 may comprise a helper based key recovery unit 22, a data decrypter 41 and a secret protection unit 42. Recovery unit 22 may receive key recovery file 49 forming part of the received backup file 51 and may generate a recovery message 27 (shown in detail in FIG. 5 hereinbelow) per helper, which message may include the recovery portion 17 associated with the helper. Recovery unit 22 may send the recovery messages 27 to message exchange service 26 via network 20. In addition, recovery unit 22 may require the user to have an oral communication 29 with each human helper 30 so that each helper may identify the user and agree to help recover the data. The user may orally provide a verification code to the helper.

Each helper may have a helper computing system 28 which, in turn, may comprise a recovery assistance unit 32. Upon activation by the helper, assistance unit 32 may pull the helper's associated recovery message 27 from message exchange service 26. Assistance unit 32 may use the helper's private key to decrypt message 27 and recovery portion 17 contained therein. Assistance unit 32 may present the user's identifying details from portion 17 to helper 30, may indicate to helper 30 to provide the verification code received orally from the user and may compare the oral verification code with a verification code stored within message 27 in order to confirm the identity of the user.

Each recovery assistance unit 32 may send the decrypted recovery portion 17 or parts of it to back to recovery unit 22, typically in an encrypted response message 34 to message exchange service 26. Service 26 may provide the multiple response messages 34 to recovery unit 22.

Recovery unit 22 may then combine the received decrypted recovery portions 17 to reconstruct snapshot protection key 48 (FIG. 2) and may utilize data decrypter 41 to decrypt encrypted concealed snapshot 47 to produce concealed snapshot 8.

In an alternative embodiment, recovery unit 22 may additionally or alternatively operate directly with at least one automated helper 31 which may include an identification application to identify the user. Automated helper 31 may provide its associated decrypted recovery portion 17 to recovery unit 22.

Backup activator 24 may then provide the decrypted concealed snapshot 8 to secret protection unit 42 which may perform a secret reconstruction process similar to that described in detail in U.S. Ser. No. 61/867,183 and in the copending PCT Application PCT/IB2014/060619, with adjustments to operate with snapshots, as described hereinbelow. Secret protection unit 42 may reconstruct snapshot 11 from concealed snapshot 8 and a password provided by the user, using a plurality N of external servers 52. At this point, old device 12 may be effectively revoked, as described in more detail hereinbelow.

Secret protection unit 42 may then perform a secret concealment on the decrypted snapshot and the user's password. At this point, the migration to new device 14 is completed and the user can resume working as usual.

It will be appreciated that, once migration has finished, secret protection unit 42 and servers 52 may enforce revocation of old device 12, as described hereinbelow. This ensures that attackers will not be able to use an old device for accessing private data or stealing identity, even if they know the password. Also, once a new backup is created, secret reconstruction unit 42 together with servers 52 may enforce revocation of all previously created concealed snapshots, so that only the last snapshot can be reconstructed from a backup. Furthermore, if attackers manage (despite all obstacles) to recover a concealed snapshot of old device 12 that is still in use and then attempt to reconstruct it with an incorrect password, the user of old device 12 may get notified via servers 52, as described hereinbelow. In such case, actions can be taken to avoid damage.

It will be appreciated that during normal operation of system 10, no information about users' devices or protected data, including passwords, cryptographic keys or their derivatives, is exposed to any person or machine.

In order to enable the migration described hereinabove, secret protection unit 42 and its servers 52 may operate with an indication that allows servers to determine whether a reconstruction request comes from reconstruction of a valid snapshot, an attempt to reconstruct a revoked (i.e. old) snapshot, normal operation of a valid device, or an old (revoked) device. For example, secret protection unit 42 and servers 52 may operate with an additional counter—a snapshot counter—to maintain a count of the number of snapshots created. Servers 52 will only operate with a secret protection unit 42 having a correct snapshot-counter value, as detailed hereinbelow.

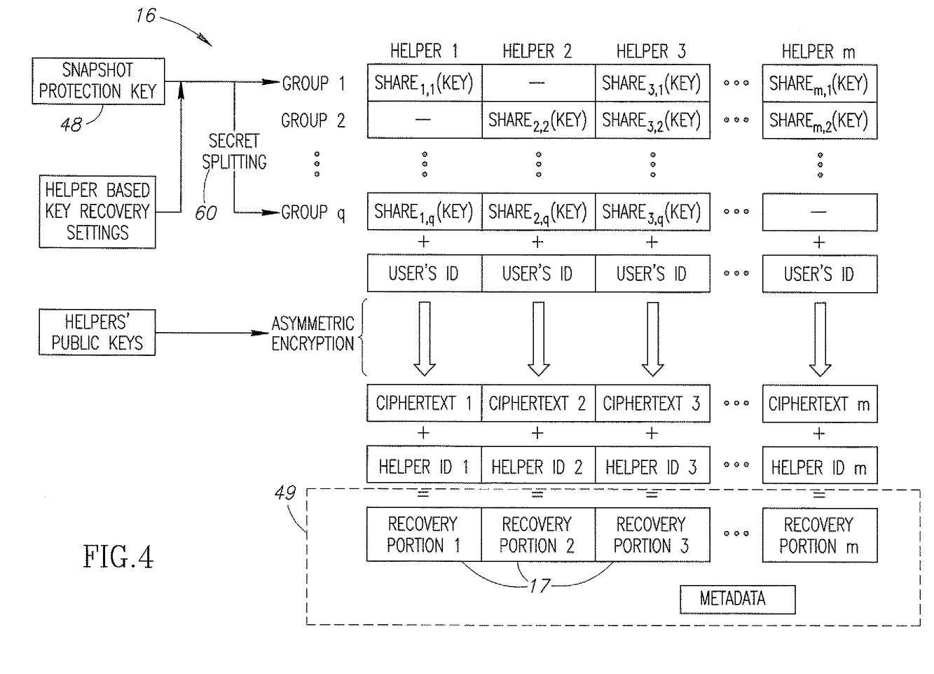

Reference is now made to FIG. 4, which illustrates the elements of the helper based key encrypter 16. In accordance with a preferred embodiment of the present invention, helpers 30 may be organized into q groups of helpers, where each helper may belong to more than one group. Encrypter 16 may perform a secret splitting algorithm 60 which may generate a share, share_{i,j}(key), per helper i per group j to which helper i may belong.

Encrypter 16 may encrypt each helper's set of shares, optionally together with identification information (ID) of the user, using that helper's public key, to generate a ciphertext for the helper. To this, encrypter 16 may add the associated helper's ID to produce the associated recovery portion 17 for that helper and may combine the portions together, along with some metadata, into key recovery file 49.

Reference is now made to FIG. 5 which illustrates the elements of recovery message 27 and response message 34. Message 27 may comprise the recovery portion 17 associated with the helper, a verification code 62 to be provided to the helper and a one-time response key 64 with which to encode the response message 34. Recovery unit 22 may encrypt these items using the public key of the associated helper 30 or 31 into recovery message 27.

Response message 34 may comprise one or more of the shareᵢⱼ(key) from the decrypted recovery portion 17, encrypted with one time response key 64, and the identification of the user.

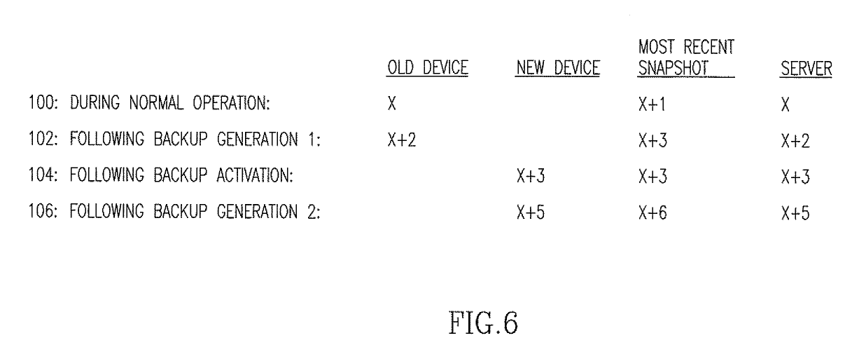

Reference is now made to FIG. 6, which illustrates the operation of secret protection unit 42 and servers 52 with the snapshot counter. The snapshot counter may be transmitted as part of a ‘messenger token’, forming part of the messages sent between unit 42 and servers 52. As described in U.S. Ser. No. 61/867,183 and in the copending PCT Application PCT/IB2014/060619, each messenger token may previously have been signed by secret protection unit 42 with a user's client-signature-key, which signature may indicate to servers 52 that the messenger token is valid.

During normal operation (step 100), old device 12 and servers 52 may have snapshot counters of value X and the messenger tokens of the most recent concealed snapshot may have a snapshot counter of X+1, since, in accordance with the present invention, the most recent snapshot should always have a snapshot counter greater than the operating value of the snapshot counter of the current device (device 12) and servers 52.

Each time a snapshot may be generated (step 102) and concealed for a backup, secret protection unit 42 on old device 12 may increment its operating snapshot counter by 2 and may generate messenger tokens for the new concealed snapshot with a snapshot counter 1 more than that of the device (i.e. X+3). Secret protection unit 42 on old device 12 may transmit a messenger token to each server 52 with its updated value (i.e. X+2) of the snapshot counter.

Each server 52 may continuously store a value for the snapshot counter. When a messenger token comes with a snapshot counter whose value is other than the stored value, each server may only continue if the new snapshot counter is greater than or equal to the stored snapshot counter. Moreover, if the value is grater, each server 52 will update its stored snapshot counter with the value in the incoming messenger token. Thus, at step 102, servers 52 receive the snapshot counter of X+2 (i.e. the current value at the device).

It will be appreciated that, when the server 52 updates the snapshot counter, the server will also update another of its counters, a stored success counter, to the value in the messenger token that had the updated snapshot counter.

Subsequent secret reconstructions occurring during normal operation of old device 12 will not affect the snapshot counters of old device 12 or of the servers 52 and thus, for the subsequent reconstructions, the device and server snapshot counters will be X+2.

When new device 14 may activate (step 104) the most recent snapshot, which has a snapshot counter of X+3, new device 14 will update (step 110) its snapshot counter to be that of the most recent snapshot (i.e. X+3). New device 14 will send the messenger tokens in the most recent snapshot, which have snapshot counters of X+3, to servers 52. Servers 52 will receive messenger tokens from new device 14 and will update their snapshot counters to X+3. Thus, any device having a snapshot counter of less than X+3 will be rejected by servers 52 from this point on.

A messenger token that belongs to a concealed snapshot may contain an indication (such as a flag) that it belongs to a snapshot. Optionally, a server which receives an indication that the messenger token comes from a snapshot rather than from normal reconstruction, will also respect messenger tokens with the lower snapshot value (X+2) until it receives the next proof of success, in accordance with the secret reconstruction process, at which point it will update the snapshot counter to the new value. After this, it will only respect requests from the new device. This mechanism will keep an attacker, who has access to the most recent concealed snapshot but does not have the password, from locking out a legitimate user.

The following description details one embodiment for the elements and processes described hereinabove.

### Definition of Terms

Digital signature: the result of applying a cryptographic digital signature algorithm such as RSA or DSA to some input data. The term can also refer to the process of performing a digital signature algorithm.

Personal identification information: data by which a person or a group of persons are identified, such as name, email address, and telephone number. Personal identification information may include non-text data such as photographs.

Personal public and private keys: one or more pairs of public and private keys which are associated with a person or a group of persons (the owners of the keys). Personal private keys are kept secret and can be accessed by their owners through an interactive computing system for the purpose of digital signature generation or decryption of asymmetrically encrypted messages. Personal private keys are protected by the system or by another method.

System identification information: details by which a computer system is identified. For example, a bank's computer system is identified by the name of the bank and possibly other details.

Identity record: a unit of data that consists of the following elements:

1. Personal or system identification information

2. One or more personal or system public keys which are associated with the identification information.

Digitally signed identity records are known as digital certificates. Unlike digital certificates, identity records are not necessarily signed. The various methods by which identity records are distributed or exchanged among computing devices are not described in this document.

Trustable identity record: an identity record which is known by a computing system as containing valid information. A trustable identity record can, but not necessarily, be digitally signed. Trustable identity records are used in the process of verifying that a given digital signature was created by a certain person or system. The various methods by which a computing system determines whether an identity record is trustable are not described in this document. Note that a computing system can mark a locally stored identity record (either signed or unsigned) as trustable, for example if a user manually defines it as such.

Secret sharing (n, k) where n and k are positive integers and n>=k: an algorithm that transforms a bit string (the secret) into n bit strings (the shares) so that the following conditions are satisfied:

1. The values of the shares cannot be predicted by external observers.

2. The secret is computable from any k shares.

3. No information about the secret can be derived from any set of less than k shares.

4. Or (alternatively to iii), deriving any information about the secret from any set of less than k shares is computationally hard.

Shamir's Secret Sharing algorithm is an example of a secret sharing algorithm that satisfies iii above.

Helper based recovery settings: configuration options that are part of the input to the helper based key encryption and helper based key recovery process, as described below. Helper based recovery settings include:

1. Identification helpers: one or more identification helpers (human or automated) that will help identify the user during key recovery. Identification helpers are identified by trustable identity records. The identification helper at position i in the list of defined helpers is referred to hereinafter as the ith identification helper.

2. Identification groups: one or more subsets of {1 . . . n} where n is the total number of defined identification helpers. Cooperation of identification helpers that correspond (according to the identification helper order) to all members of one of the identification groups is required in order to complete the key recovery process. Identification groups may be defined by explicitly listing their members or they may be defined in terms of rules for combining members of other subsets, for example: all combinations of 2 members of {1 . . . n}. No identification group contains all members of another identification group. Referring to the identification groups listed in some fixed order, the identification group at position j in the list is denoted hereinafter the jth identification group.

### Description of Elements

Secret splitting 60: an algorithm that receives the following input:

1. A bit string (the secret)

2. An ordered collection of m subsets of {1 . . . n} where m and n are positive integers. The subset at position j according to the given order is referred to as the jth subset.

The algorithm produces a collection of bit strings (the shares) such that the following conditions are satisfied:

1. The output of the algorithm comprises one value, denoted shareᵢⱼ(s) where s is the secret, for every integers i and j such that 1<=i<=n, 1<=j<=m and i belongs to the jth subset. Note that depending on the input subsets and the details of the secret splitting algorithm, some of the output values (the shares) can be identical to other output values. In such case the total memory footprint of the output can be significantly reduced compared to a situation in which no 2 values are identical.

2. For each j where 1<=j<=m the secret is computable from the collection of all shareᵢⱼ(s) such that i belongs to the jth subset.

3. Deriving information about the secret from a subset of the shares that does not contain any of the sets defined in ii is infeasible.

An example of a secret splitting algorithm (trivial secret splitting): If the input subsets are all k-sized subsets of {1 . . . n} where 1<=k<n then the shares are formed by applying secret sharing (n,k) to the secret. In this case shareᵢⱼ(s) for 1<=j<(ₖⁿ) is defined as the ith output value. Otherwise, for every j 1<=j<=m and 1<=i<=n such that i belongs to the jth subset, the values shareᵢⱼ(s) are created by applying secret sharing (qⱼ, qⱼ) to the secret where qⱼ is the size of the jth subset.

### Helper Based Key Encrypter 16

An exemplary operation of helper based key encrypter 16 is now described. The input to encrypter 16 comprises a secret cryptographic key, such as snapshot protection key 48, and the helper based recovery settings as described above. The output of the process is key recovery file 49. The process proceeds as follows:

1. As shown in FIG. 4, the secret key is split into shares by applying secret splitting algorithm 60 (as defined above) to the secret key and the defined identification groups. The output value that corresponds to the ith identification helper and the jth identification group where i belongs the jth identification group is referred to as shareᵢⱼ(key) hereinafter.

2. For 1<==i<==m where m is the total number of identification helpers 30/31, a unit of data, denoted ith recovery portion (or recovery portion i), is created. The ith recovery portion consists of the following elements:

A. The collection of shareᵢⱼ(key) for 1<=j<=m where m is the number of identification groups, such that i belongs to the jth identification group.

B. Identification information or identity record of the user.

C. Identity record of the ith identification helper. The identity record includes the public key which was used for encrypting the above elements.

The collection of shares, and the identification information of the user, are asymmetrically encrypted with a public encryption key of the ith identification helper. Optionally, the above information is digitally signed with a personal private signature key of the user and the signature is included in the ith recovery portion.

The resultant recovery file consists of:

1. The collection of all recovery portions.

2. The helper based recovery settings which were used as input to the above process.

### Helper Based Key Recovery Unit 22

An exemplary operation of recovery unit 22, together with message exchange service 26, helpers 30 and 31, and helper computing system 28 (shown in FIG. 3) is now described.

1. Recovery unit 22 extracts the names and optionally other identification information of the identification helpers from the recovery file and displays them on the device's screen. The user confirms.

2. A one-time verification code (sequence of symbols) is randomly generated by recovery unit 22 and displayed on the device's screen. The user is instructed by the recovery unit 22 to contact the human identification helpers of one or more identification groups (if such helpers are defined) and to orally pass them the verification code. Note that the terms “identification helper” and “helper” are used interchangeably hereinafter.

3. Recovery unit 22 creates (at the background) recovery message 27 (shown in FIG. 5), for each of the identification helpers. The recovery message that is addressed to the ith helper contains:

A. The recovery portion (from the backup file) that corresponds to the ith identification helper.

B. The verification code (as shown to the user).

C. Response key—a one-time randomly picked symmetric encryption key for encrypting the response.

The above elements are asymmetrically encrypted with a public encryption key of the ith identification helper. The public key is taken from the recovery portion.

D. Identification information of the helper (for message lookup).

4. Recovery unit 22 sends the recovery messages to the message exchange service 26 where they wait. Message exchange service 26 keeps the recovery messages until demanded. If a message is not demanded within a fixed amount of time, the message exchange service discards it. Note that no notification messages are sent to helpers, which makes it hard for potential attackers to bother the helpers or attempt to deceive them.

5. The user contacts the first human helper (if such helper is defined) and requests their cooperation.

6. The helper starts the recovery assistance unit 32 at their computing system 28.

7. Optionally, the helper is required to provide their personal password to assistance unit 32 in order to gain access to their personal private keys

8. Assistance unit 32 sends a request to message exchange service 26 to retrieve recovery message 27. Message exchange service 26 uses the helper's identification information contained in the request message for looking up the appropriate recovery message at the service. Recovery message 27 is then loaded to the helper's computing system, where it gets decrypted with the appropriate helper's private decryption key.

9. Assistance unit 32 decrypts recovery message 27 and the recovery portion 17 contained therein, and performs validation as follows:

A. If the contained recovery portion is digitally signed, verifies that the digital signature is valid and matches the user's identity record contained in the recovery portion.

B. Optionally (depending on policy), verifies that the contained user's identity record is trustable.

10. Assistance unit 32 extracts the user identification information from the recovery portion and displays the name and details of the user to the helper (on his/her client device screen). If the above validation succeeds, an indication that the information is valid is also displayed.

11. The helper is requested by assistance unit 32 to enter the verification code. The helper is warned that the verification code must be passed orally by the user. The helper is requested to confirm that they identified the user with no doubt.

12. The helper confirms and enters the verification code.

13. Assistance unit 32 verifies that the entered verification code matches the value included in the recovery message. It then creates response message 34 (shown in FIG. 5), that contains the following information:

A. One or more of the shareᵢⱼ(key) from the decrypted recovery portion. This data is encrypted with the symmetric key that was previously received in the recovery message.

B. Identification information of the user (taken from the recovery message, for the sake of message lookup).

14. Assistance unit 32 sends the recovery response message 34 to the message exchange service 24.

15. Recovery unit 22 pulls the recovery response message from the message exchange service 26 and displays an indication that the first identification phase has completed.

16. Depending on the recovery settings, the user might need to repeat the identification process with other helpers. For automated identification helpers 31, the identification process is identical except for the following differences:

A. Instead of making contact with the helper, recovery unit 22 directs the user to an interactive program, referred to as the identification application hereinafter, that performs the interaction between the user and the automated identification helper. The connection between the client device and the identification helper is done via an encrypted connection such as SSL. During secure session initialization, the device performs server authentication to verify that the system on the other side matches the helper's identity record which is contained in the corresponding recovery portion.

B. Optionally, recovery unit 22 transmits the recovery message to the automated identification helper over the network directly instead of via the message exchange service.

C. The step of transmitting the verification code to the helper is skipped.

D. Instead of the oral conversation between the user and the helper, the identification application interacts with the user in order to identify him/her. If identification completes successfully then the automated identification system creates the recovery response message and sends it to the user's recovery unit 22 over the network directly or through the message exchange service.

17. Upon completion of identification by all identification helpers of one of the identification groups, recovery unit 22 decrypts the recovery response messages and retrieves the shares of snapshot protection key 48. It then reconstructs key 48 from the shares.

### Chains of Key Recovery Files

A chain of recovery files (of length 2) is formed by encrypting a key recovery file with a new symmetric encryption key and applying helper based key encryption (with different helper based recovery settings) to the new key. This scheme is useful in cases where some identification helpers are less trustable than others or are more likely of being a target to attacks than others. For example, hackers could exploit an automated identification helper in order to learn sensitive information about the user. This type of attack starts by obtaining a recovery file and then repeatedly initiating the identification process against the automated identification helper until the identification helper stops responding to requests that relate to the attacked recovery file or until the attackers learn information about the owner of the recovery file. This risk can be minimized by applying a chain of recovery files where the recovery file that relies on the automated identification helper is protected by another recovery file which relies on human identification helpers.

### Adjustments to the Secret Protection System to Work with Snapshots

In order to allow effective revocation of old concealed snapshots, when a new snapshot is created, and revocation of old personal computing devices, upon snapshot activation, the following adjustments are made to the multiparty secret protection system.

### Adjustments to the Secret Concealment Process

The following information is added to every messenger token:

1. snapshot-counter: a numeric value that gets incremented each time that a new snapshot file is created for the user's snapshot, as described below.

### Adjustments to the Secret Reconstruction Server

A numeric variable, denoted snapshot-counter, is added to each entry of the server-side client-state repository. This variable is used during messenger token validation, as described below.

### Adjustments to the Secret Reconstruction Process

The following step is added to the validation of an incoming messenger token by each of servers 52. This step immediately follows the signature validation step.

1. Compare the snapshot-counter value in the messenger-token with the snapshot-counter value in the server-side client-state.

A. If the former is bigger than the latter then:

i. Update the snapshot-counter value in the client-state to the bigger value.

ii. Update the success-counter value in the client-state to the value of the success-counter in the messenger token.

B. If the former is smaller than the latter then the validation fails and the message that contains the messenger token is discarded. Optionally, a response message is sent to the client, indicating that the request has been rejected due to too small snapshot-counter value.

In the next step of the validation of the messenger token, servers 52 check the incoming success-counter against a stored success-counter as described in U.S. Ser. No. 61/867,183 and in the copending PCT Application PCT/IB2014/060619. If the stored success-counter was just updated, the incoming success-counter will match the stored success-counter and thus, the messenger token will be accepted.

In a preferred embodiment of the invention, secret reconstruction servers 52 increment the snapshot-counter value in the server-side client-state only upon receipt of a valid messenger-token that contains a snapshot-counter value bigger than that stored in the server-side client-state and a success-counter value bigger than zero. As shown below, any messenger token with success-counter of value zero belongs to a concealed snapshot. This ensures that attackers who manage to recover a concealed snapshot from a leaked backup file cannot block a legitimate user by attempting to reconstruct the snapshot with an incorrect password, hi order to allow such server behavior, every entry in the server-side client-state repository of servers 52 is duplicated: a primary client-state is used in processing of ordinary client requests, whereas a secondary client-state is used in processing of valid snapshot activation requests. This setup also allows servers to send an indication to clients if an attempt to activate the snapshot has been made. Such indication may be included in a response to an ordinary secret reconstruction request from old device 12. It will be appreciated that the indication that a messenger token belongs to a concealed snapshot may be embodied in various ways, e.g. by including a flag in every messenger token.

### Backup Configuration

In order to enable backups, the following options need to be set and stored on device 12:

1. Helper based key recovery settings as described above.

2. Backup lookup key: a datum, such as the user's email address, that is used as a key for storage and retrieval of backup files at backup repository 18.

Note that setting or changing the above configuration by the user requires user authentication.

### Backup Generator 13

Backup files allow users to migrate their private sensitive data which is regularly protected by the multiparty secret protection system from one device to another when the first device is absent. The content of a backup includes a snapshot of the user's sensitive data and optionally other data, such as configuration settings.

Backup files are created automatically by backup generator 13 (shown in FIG. 1 and FIG. 2) whenever the user's protected data, the password, or the backup configuration, get updated. Construction of backup files by backup generator 13 always occurs while the user performs an operation (such as digital signature) that involves access to the protected data, at which point both the user's password and the user's protected data is available unencrypted to backup generator 13 on device 12. An exemplary operation of backup generator 13 on device 12 is now described.

1. The secret protection unit 42 increments the snapshot-counter value by 2. Note that the snapshot-counter is incremented only when a new backup file is constructed.

2. In order to ensure that the former backup file is revoked by servers 52 without delay, unit 42 repeats the secret concealment process and the secret reconstruction process with the new snapshot-counter value.

3. Unit 42 takes a snapshot 11 of the user's private data and performs the secret concealment process to snapshot 11 and the user's password. The snapshot-counter value that applies to concealment of the snapshot is always 1 more than the current snapshot-counter value, and the value of the success-counter is zero (or another constant value), i.e., each of the messenger tokens that comprise the concealed snapshot has these values.

4. Backup generator 13 picks snapshot protection key 48 as a random symmetric key.

5. Helper based key encrypter 16 operates on snapshot protection key 48 and the previously defined helper based recovery settings, producing key recovery file 49.

6. Backup generator 13 composes backup 51 which comprises:

1. The encrypted concealed snapshot 47

2. The snapshot protection key recovery file 49

3. Metadata including:

i. The snapshot lookup key.

ii. Digital signature on all of the above. The signature is created with a personal private key of the user.

iii. Identity record of the user which contains a public key that matches the above digital signature.

7. Backup generator 13 sends backup file 51 (over the network) to backup repository 18 for storage.

8. Backup repository 18 receives backup file 51 and performs validation as follows:

A. Extracts the digital signature and the user's identity record from the snapshot file and verifies that the signature matches the signed data and the user's public key.

B. Verifies that no snapshot file exists at the repository with the same lookup key but signed with a different public key.

C. Optionally (depending on policy), verifies that the user's identity record contained in the snapshot file is trustable.

If validation fails then repository 18 rejects the received snapshot file and sends a notification message back to device 12. Otherwise, the received snapshot file is stored at the repository. Older snapshot files with the same lookup key, if such exist, are removed from repository 18 and discarded.

### Incremental Backups

A method that allows device 12 to update the content of the most recent backup from time to time, without generating a new backup file from a new snapshot, is now described. In order to add content to an existing secure backup, device 12 encrypts the new content with an asymmetric public encryption key, where the corresponding private decryption key is included in the concealed snapshot 11 of the most recent backup file 51. Device 12 will then store the new encrypted content in backup repository 18 or elsewhere. Following backup activation at new device 14, device 14 will recover the decryption private key from the backup, download the asymmetrically encrypted content from where it's stored, and decrypt it with the private key.

### Backup Activator 24

An exemplary operation of backup activator 24 together with backup repository 18 and servers 52 (shown in FIG. 1 and FIG. 3), is now described.

1. The user starts backup activator 24.

2. Optionally, the user is requested by the new backup activator 24 to enter their snapshot lookup key at the device. If the snapshot lookup key is already available to the device (for example if the lookup key is defined to be the telephone number) then this step is skipped.

3. If requested, the user provides his\her snapshot lookup key to backup activator 24.

4. Backup activator 24 sends a request to backup repository 18 to retrieve the latest backup that matches the lookup key. In response the backup repository sends the latest backup file 51 back to backup activator 24.

5. Backup activator 24 extracts the user's identity record from backup file 51 and displays the user's identification information on the device's screen. The user is requested to confirm.

6. The user observes the information and confirms (if the information is correct).

7. Backup activator 24 extracts key recovery file 49 from backup file 51 and invokes the key recovery unit 22 to lead the user through the key recovery process as described above. At the end of this process the snapshot protection key 48 is recovered at device 14.

8. Backup activator 24 utilizes data decrypter 41 to decrypt the encrypted concealed snapshot 47.

9. The user is requested by activator 24 to enter the password (the password remains the same as before the migration).

10. The user enters the password. Backup activator 24 then utilizes secret protection unit 42 to perform the secret reconstruction process, which reconstructs snapshot 11. At this point old device 12 is effectively revoked, as the snapshot-counter value in the concealed snapshot being reconstructed, and accordingly the new snapshot counter value stored at servers 52 are higher than that of old device 12.

11. Secret protection unit 42 applies secret concealment process to the reconstructed snapshot 11. At this point the migration is completed and the user can resume working as usual.

It will be appreciated that the present invention may conceal snapshot 11, as shown, or may conceal a decryption key for snapshot 11.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A device comprising:
a helper based key recovery unit to send encrypted portions of a protection key to a message exchange service, each said portion being associated with at least one helper, and to combine decrypted portions into said protection key, said decrypted portions being received from said message exchange service after a user of said device requests that each at least one helper retrieve his or her associated portion from said message exchange service and after said at least one helper enables his or her associated portion to be decrypted using his or her private key and sent back to said message exchange service; and
a helper based key encrypter to split said protection key into at least one portion per associated helper and to encrypt each portion with said associated helper's public key.

2. The device according to claim 1 and wherein said helper based key encrypter comprises:
a secret splitter to split said protection key into at least one secret share per associated helper; and
an encrypter to encrypt said at least one secret share per associated helper together with an identification of said user using said associated helper's public key into a ciphertext per associated helper.

3. The device according to claim 2 and wherein said helper based key encrypter also comprises a combiner to combine each ciphertext per helper with at least an identification of its associated helper to generate said portion per associated helper.

4. The device according to claim 2 wherein said helpers are organized into groups, and wherein each helper has one share per each said group to which s/he belongs.

5. The device according to claim 1 and wherein at least one of said associated helpers is an automated helper which communicates with said helper based key recovery unit directly.

6. The device according to claim 1 and wherein said key recovery unit comprises a code provider to generate a verification code and to instruct said user to provide said verification code to at least one said helper via an oral communication.

7. The device according to claim 6 and wherein said key recovery unit comprises a message generator to generate a recovery message per helper, wherein each message comprises at least one of an associated encrypted portion for said helper, said verification code associated with said helper and a response key for said helper.

8. The device according to claim 7 wherein each helper has a helper assistance unit to receive said recovery message, to decrypt said associated encrypted portion with said helper's public key, said encrypted portion comprising an identification of said user, to present said identification of said user to said helper, to receive said verification code for said user from said helper, to compare said verification code from said helper to said verification code in said recovery message, and to transmit the decrypted associated portion back to said message exchange service.

9. The device according to claim 7 and wherein said key recovery unit comprises a message receiver to receive a response message from at least one said helper, each encrypted with said response key for said helper and comprising said decrypted portion associated with said helper.

10. The device according to claim 1 and also comprising:
a backup activator to decrypt an encrypted concealed snapshot of a user's secret, producing a concealed snapshot, using the output of said recovery unit and to reconstruct a snapshot from said concealed snapshot, said user's password and a multiparty secret reconstruction system;
a backup generator to conceal said snapshot with a password of said user and said multiparty secret protection system, to generate said protection key and to encrypt the concealed snapshot with said protection key.

11. The device according to claim 10 wherein said multiparty secret protection system operates with snapshot counters to enable servers of said multiparty secret protection system to determine whether a reconstruction request comes from reconstruction of a valid snapshot, a reconstruction attempt of a revoked snapshot, normal operation of a valid device, or a revoked device.

12. A device comprising:
a backup activator to decrypt an encrypted concealed snapshot of a user's secret using a protection key, producing a concealed snapshot, and to reconstruct a snapshot from said concealed snapshot, said user's password and a multiparty secret reconstruction system, said backup activator comprising:
a helper based key recovery unit to send encrypted portions of said protection key, each said portion being associated with and decryptable by a helper, and to combine decrypted portions into said protection key; and
a backup generator to conceal said snapshot with a password of said user and said multiparty secret protection system, to generate said protection key and to encrypt the concealed snapshot with said protection key, said backup generator comprising:
a helper based key encrypter to split said protection key into at least one portion per an associated helper and to encrypt each portion with said associated helper's public key.

13. A method comprising:
sending encrypted portions of a protection key to a message exchange service, each said portion being associated with at least one helper;
combining decrypted portions into said protection key, said decrypted portions being received from said message exchange service after a user requests that each at least one helper retrieve his or her associated portion from said message exchange service and after said at least one helper enables his or her associated portion to be decrypted using his or her private key and sent back to said message exchange service;
splitting said protection key into at least one portion per associated helper; and
encrypting each portion with said associated helper's public key.

14. The method according to claim 13 and wherein said splitting comprises secret splitting said protection key into at least one secret share per associated helper; and wherein said encrypting comprises encrypting said at least one secret share per associated helper together with an identification of said user using said associated helper's public key into a ciphertext per associated helper.

15. The method according to claim 14 and wherein said encrypting also comprises combining each ciphertext per helper with at least an identification of its associated helper to generate said portion per associated helper.

16. The method according to claim 14 wherein said helpers are organized into groups, and wherein each helper has one share per each said group to which s/he belongs.

17. The method according to claim 13 and wherein at least one of said associated helpers is an automated helper and wherein said sending sends said encrypted portions directly to said automated helper.

18. The method according to claim 13 and wherein said combining comprises generating a verification code and instructing said user to provide said verification code to at least one said helper via an oral communication.

19. The method according to claim 18 and wherein said combining comprises generating a recovery message per helper, wherein each message comprises at least one of an associated encrypted portion for said helper, said verification code associated with said helper and a response key for said helper.

20. The method according to claim 19 and also comprising each helper having a helper assistance unit to receive said recovery message, to decrypt said associated encrypted portion with said helper's public key, said encrypted portion comprising an identification of said user, to present said identification of said user to said helper, to receive said verification code for said user from said helper, to compare said verification code from said helper to said verification code in said recovery message, and to transmit the decrypted associated portion back to said message exchange service.

21. The method according to claim 13 and also comprising:
decrypting an encrypted concealed snapshot of a user's secret to produce a concealed snapshot, using the output of said combining;
reconstructing a snapshot from said concealed snapshot and said user's password, with a multiparty secret reconstruction system;
concealing said snapshot with a password of said user and said multiparty secret protection system;
generating said protection key; and
encrypting the concealed snapshot with said protection key.

22. The method according to claim 21 wherein said multiparty secret protection system operates with snapshot counters to enable servers of said multiparty secret protection system to determine whether a reconstruction request comes from reconstruction of a valid snapshot, a reconstruction attempt of a revoked snapshot, normal operation of a valid method, or a revoked method.

23. A method comprising:
decrypting an encrypted concealed snapshot of a user's secret using a protection key, producing a concealed snapshot;
reconstructing a snapshot from said concealed snapshot, said user's password and a multiparty secret reconstruction system, said decrypting comprising:
sending encrypted portions of said protection key, each said portion being associated with and decryptable by a helper, and
combining decrypted portions into said protection key; and
concealing said snapshot with a password of said user and said multiparty secret protection system;
generating said protection key and encrypting said concealed snapshot with said protection key, said generating comprising:
splitting said protection key into at least one portion per an associated helper; and
encrypting each portion with said associated helper's public key.
